(19) United States
(12) Patent Application Publication
(10) Pub. No.: US 2010/0040805 A1
(43) Pub. Date: Feb. 18, 2010

(54) Antistatic Coating Composition for Polarizer Films and Antistatic Polarizer Film using the Same

(76) Inventors: Kwang Suck Suh, Gyeonggi-do (KR); Jong Eun Kim, Seoul (KR); Tae Young Kim, Seoul (KR); Won Jung Kim, Seoul (KR); Tae Hee Lee, Seoul (KR)

Correspondence Address: PARK LAW FIRM, 3255 WILSHIRE BLVD, SUITE 1110, LOS ANGELES, CA, 90010, US

(21) Appl. No.: 12/282,945

(22) PCT Filed: Mar. 13, 2007
(86) PCT No.: PCT/KR2007/001232

§ 371 Date: Oct. 16, 2009

(30) Foreign Application Priority Data
Mar. 14, 2006 (KR) 10-2006-0023302

(51) Int. Cl. C09K 19/00; H01B 1/12

(52) U.S. Cl. 428/1.4; 252/500

(57) ABSTRACT

Disclosed is a conductive polymer composition for a polarizer film to impart the surface of the polarizer film for liquid crystal displays with antistatic performance. The composition is applied on the surface of the polarizer film without additional surface treatment and is then dried, thereby manufacturing a highly reliable antistatic polarizer film, which has high adhesive strength between the polarizer film and the adhesive layer and also results in no transfer of the adhesive layer of the polarizer film to a glass or transparent polymer substrate when the polarizer film is attached to the substrate and then separated therefrom.

### TECHNICAL FIELD

The present invention relates to an antistatic composition for polarizer films, in order to impart the polarizer film, for use in liquid crystal displays, with antistatic performance, and to an antistatic polarizer film manufactured using the same.

### BACKGROUND ART

Generally, a liquid crystal display panel is manufactured in a form in which a liquid crystal component is injected between two glass or transparent polymer film substrates, respectively having a thin film transistor (TFT) and a color filter. As such, a polarizer film is adhered to the outer surfaces of the two substrates. The polarizer film, which is a film formed by attaching a cellulose-based transparent polymer film to both surfaces of a polarizer composed of a polyvinylalcohol (PVA) film and a dichromatic material, such as iodine, allows light supplied from a light source to vibrate in only one direction so as to be incident on the liquid crystal panel. The polarizer film is used in a state of being attached to the TFT or color filter substrate. To this end, an acrylic adhesive or a methacrylic adhesive is applied on one surface of the polarizer film, which is adhered to the substrate. Further, a release film is attached to the upper surface of the adhesive layer.

In a module process for attaching the polarizer film to the substrate, the release film is removed and then the adhesive surface of the polarizer film is adhered to the substrate under predetermined pressure. As such, since a conventional polarizer film is not subjected to antistatic treatment, static electricity having a high charging voltage of about 20 kV or more occurs upon removal of the release film, thereby causing various electrostatic problems. For example, static electricity, which occurs on the adhesive surface of the polarizer film after the release film is removed, causes electrostatic attraction, thus adsorbing surrounding impurities and undesirably attaching the impurities to the polarizer film. Further, while static electricity is electrically discharged from the polarizer film, the metal pattern of the TFT may break down. Furthermore, when the polarizer film, which is in an electrostatic state, is adhered to the substrate, the state of orientation of liquid crystals that are filled between the substrates is distorted due to static electricity, whereby a subsequent process is not conducted but must be delayed for a considerable period of time. Moreover, in the case where the liquid crystals are not restored to the original state thereof, they are subjected to an additional process such as heat treatment and then introduced to the subsequent process. In the severe case, even after the additional process is performed, the state of orientation of the liquid crystals is not restored, and thus it is impossible to use them.

In order to mitigate such electrostatic problems, there have been proposed conventional methods in which a plurality of ionizers is mounted around the process apparatus for attaching the polarizer film to the substrate to thereby neutralize the static electricity occurring on the polarizer film with ions having the opposite polarity. However, since the method is used to artificially neutralize the considerable amount of static electricity, which is generated on the polarizer film, it is virtually impossible to use it to suppress the generation of static electricity itself. Accordingly, to solve the problems, it is most preferred that the polarizer film be directly subjected to antistatic treatment so that the generation of static electricity on the polarizer film be minimized.

Conventional techniques for subjecting the surface of the polarizer film to antistatic treatment include methods of using an ionic or non-ionic surfactant as an antistatic agent and of using a conductive polymer as an antistatic agent. The method of using the surfactant as an antistatic agent is a temporary technique because antistatic performance is attained shortly after the coating process using the surfactant, but disappears after a period of time of several months. The antistatic properties using the surfactant are exhibited by combining the surfactant with surrounding water molecules and therefore are highly dependent on humidity. In the case of the ionic surfactant, it has a high probability of causing ionic impurities, and thus the practical use thereof is limited.

In order to solve such problems, a method of applying a conductive polymer on the surface of a polarizer film is disclosed (Korean Patent Application No. 10-2005-0118303). Among the conductive polymers, poly(3,4-ethylenedioxythiophene) (PEDOT), available from H.C. Starck, Germany, is easily processed, is highly transparent, and undergoes almost no changes in electrical conductivity over time, and is thus very useful as an antistatic agent for polarizer films. That is, when an antistatic layer including poly(3,4-ethylenedioxythiophene) as an effective component is formed between the polarizer film and the adhesive of the polarizer film, the generation of static electricity upon removal of the release film, which is used to attach the polarizer film to the substrate, can be effectively controlled, thus solving the above electrostatic problems.

In the case where the antistatic layer including poly(3,4-ethylenedioxythiophene) as an effective component is formed on the surface of the polarizer film, the polarizer film may be imparted with antistatic performance, but the following process problems may be incurred. In the module process for attaching the polarizer film to the substrate, the adhesive surface of the polarizer film after the release film is removed is attached to the substrate under predetermined pressure. As such, when the polarizer film is improperly attached to the substrate, it should be detached from the substrate in the inspection process. The process of separating the polarizer film, which is improperly attached, from the substrate to thus rework it, is referred to as a “rework process”. In this way, in the separation of the polarizer film from the substrate, only when the adhesive of the polarizer film is completely removed from the substrate, it is possible to use the glass substrate again through the rework process. In the case where the antistatic layer is formed between the polarizer film and the adhesive of the polarizer film, a problem, in which the adhesive of the polarizer film is not completely removed in the rework process but remains on the substrate, may arise. This is because the adhesive strength between the polarizer film and the adhesive is decreased due to the antistatic layer formed between the polarizer film and the adhesive. To mitigate the problem, a composition for an antistatic layer, which is able to prevent the decrease in the adhesive strength between the polarizer film and the adhesive, should be improved.

That is, an antistatic layer including poly(3,4-ethylenedioxythiophene) or modified conductive polymer thereof as an effective component is formed on the surface of the polarizer film, and an adhesive layer is formed on the antistatic layer, thereby manufacturing an antistatic polarizer film. For this, there is a need to develop a novel antistatic coating composition having a conductive polymer to increase the adhesive strength between the polarizer film and the adhesive layer in order to completely remove the adhesive from the substrate in the rework process, and an antistatic polarizer film manufactured using the same.

### DISCLOSURE OF INVENTION

### Technical Problem

Accordingly, the present invention has been made keeping in mind the above problems occurring in the prior art, and an object of the present invention is to provide an antistatic coating composition for polarizer films, which is able to completely remove an adhesive layer from a substrate, that is, to maximize the adhesive strength between the polarizer film and the adhesive layer when attaching the polarizer film, manufactured by forming an antistatic layer having a conductive polymer as an effective component on the polarizer film and then forming the adhesive layer on the antistatic layer, to the surface of the substrate and then separating it, and also to provide an antistatic polarizer film product manufactured using such a composition.

### Technical Solution

In order to achieve the above object, the present invention provides an antistatic coating composition for a polarizer film, comprising a conductive polymer and an organic acid compound, mixed together, to apply the composition between the polarizer film and the adhesive layer so as to manufacture an antistatic polarizer film.

That is, the antistatic coating composition for a polarizer film of the present invention comprises a conductive polymer as an effective component, and further includes an organic acid compound, and thus is applied between the polarizer film and the adhesive layer.

In addition, the present invention provides an antistatic polarizer film, comprising a base film, an antistatic layer formed on one surface of the base film using the above composition, and an adhesive layer formed on the antistatic layer.

### Advantageous Effects

According to the present invention, an antistatic layer can be formed on the surface of a polarizer film, without additional surface treatment, such as primer treatment or corona treatment, thus manufacturing a polarizer film causing no concern about the generation of static electricity upon the removal of a protecting film or a release film from the polarizer film.

Further, according to the present invention, it is possible to rework the polarizer film, and therefore the polarizer film, which is in a defective state, is not wasted but may be recycled upon the manufacturing process thereof.

### BRIEF DESCRIPTION OF THE DRAWINGS

FIG. 1 is a sectional view showing the antistatic polarizer film, according to the present invention.

### BEST MODE FOR CARRYING OUT THE INVENTION

Hereinafter, a detailed description will be given of a composition for an antistatic layer and a preparation method thereof, in the antistatic polarizer film according to the present invention, with reference to the appended drawing.

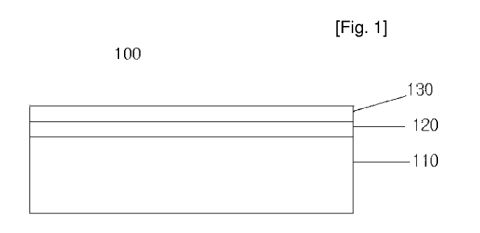

FIG. 1 is a sectional view showing the antistatic polarizer film according to the present invention. As shown in FIG. 1, the antistatic polarizer film 100 comprises a polarizer film 110, an antistatic layer 120 having a conductive polymer as an effective component formed on one surface of the polarizer film 110, and an acrylic adhesive layer 130 for polarizer films formed on the antistatic layer 120.

As the polarizer film 110, useful is a film formed by attaching a cellulose-based transparent polymer film to both surfaces of a polarizer composed of a polyvinylalcohol (PVA) film and a dichromatic material, such as iodine.

In the present invention, the antistatic layer 120 is formed by applying an antistatic solution including a conductive polymer as an effective component on one surface of the polarizer film and then drying it. The antistatic solution is basically composed of the conductive polymer, an organic acid compound, and a solvent. As such, it is preferred that the amount of the organic acid compound be set in the range of 1˜50 times the amount of the conductive polymer.

In the antistatic solution, the conductive polymer is exemplified by polyaniline, polypyrrole, polythiophene, or modified conductive polymers as derivatives thereof. In particular, as the derivative of polythiophene, poly(3,4-ethylenedioxythiophene) has higher electrical conductivity, higher transmittance in the visible light range, and superior thermal stability compared to the other conductive polymers, and thus is suitable for use as an antistatic material for polarizer films. In addition, conductive polymers, including polythiophene-based derivatives having optical properties similar to poly(3,4-ethylenedioxythiophene), may exhibit the same effect. Examples of conductive polymers belonging thereto include hydroxymethylated poly(3,4-ethylenedioxythiophene), poly(3,4-alkylenedioxythiophene), poly(3,4-dialkylthiophene), poly(3,4-cycloalkylthiophene), poly(3,4-dialkoxythiophene), modified conductive polymers derived therefrom, etc. Furthermore, useful is a conductive polymer, which has the structural unit of the poly-thiophene-based conductive polymer and is in the form of being copolymerized with a general polymer, such as polyethyleneglycol and poly(meth)acrylate.

In the antistatic solution, examples of the organic acid compound include polysulfonic acid compounds, such as polystyrenesulfonic acid and polyvinylsulfonic acid, and polycarboxylic acid compounds, such as polyacrylic acid, polymethacrylic acid, and polymaleic acid. In addition to the polysulfonic acid compound or poly-carboxylic acid compound, there are exemplified low-molecular-weight organic acid compounds, such as para-toluenesulfonic acid, benzenesulfonic acid, methanesulfonic acid, and trifluoromethanesulfonic acid. The organic acid compound may be used alone or in mixtures of two or more thereof.

The organic acid compound is used in an amount of 1˜50 times the amount of the conductive polymer, in particular, poly(3,4-ethylenedioxythiophene) or thiophene-based conductive polymer derived therefrom, thus preparing an antistatic solution, which is then applied on the polarizer film, yielding an antistatic layer. If so, the adhesive strength between the antistatic layer and the adhesive layer formed thereon is not decreased. Thus, when the polarizer film is separated from the substrate in the rework process, problems related to the transfer of the adhesive to the substrate can be effectively overcome. In the preparation of the antistatic solution, the ratio of the amount of the thiophene-based conductive polymer to the amount of the organic acid compound is regarded as a very important factor. When the amount of the organic acid compound is less than the amount of the conductive polymer, the adhesive strength between the adhesive layer and the antistatic layer is low, undesirably resulting in the transfer of the adhesive to the substrate in the rework process. On the other hand, when the amount of the organic acid compound is 50 or more times the amount of the thiophene-based conductive polymer, the adhesive force between the adhesive layer and the antistatic layer is not significantly increased, and furthermore, the antistatic effect may be decreased.

The conductive polymer and the organic acid compound are mixed together with an appropriate solvent. Examples of such a solvent usable in the invention include water, alcohol solvents, such as methylalcohol, ethylalcohol, isopropylalcohol and isobutyl alcohol, ketone solvents, such as acetone, methylethylketone, methylisobutylketone, and cyclohexanone, ether solvents, such as diethylether, dipropyl ether and dibutyl ether, alcohol ether solvents, such as ethyleneglycol, propyleneglycol, ethyleneglycol monomethylether (methylcellosolve), ethyleneglycol monoethylether (ethylcellosolve), ethyleneglycol monobutylether (butylcellosolve), diethyleneglycol, diethyleneglycol monoethylether, and diethyleneglycol monobutylether, amide solvents, such as N-methyl-2-pyrrolidinone, 2-pyrrolidinone, N-methylformamide, and N,N-dimethylformamide, sulfoxide solvents, such as dimethylsulfoxide and diethyl sulfoxide, sulfone solvents, such as diethyl sulfone and tetramethylene sulfone, nitrile solvents, such as acetonitrile, amine solvents, such as alkylamine, cyclic amine and aromatic amine, and organic solvents, such as toluene and xylene, which may be used alone or in mixtures of two or more thereof.

The antistatic composition for polarizer films, prepared by mixing the conductive polymer, the organic acid compound, and the solvent, is applied on the surface of the polarizer film, and furthermore, the adhesive layer is formed on the antistatic layer, thereby manufacturing an antistatic polarizer film which exhibits excellent antistatic performance and does not decrease the adhesive strength between the polarizer film and the adhesive layer due to the antistatic layer.

The antistatic layer formed on the polarizer film is composed of the conductive polymer and the organic acid compound mixed at a predetermined ratio. The process of forming the antistatic layer on the polarizer film may vary depending on the type of polymerization of the conductive polymer.

For example, a solution of typical conductive polymer, which has been polymerized, is mixed with an organic acid compound at a predetermined ratio, thus preparing an antistatic solution for polarizer films, which is then applied on the polarizer film and dried, thereby forming the antistatic layer. Alternatively, an organic acid compound is first mixed with a polymerization initiator for a conductive polymer and is then applied on the surface of a polarizer film, after which a monomer for a conductive polymer is gasified to thus come into contact with the surface of the polarizer film, thereby making it possible to form an antistatic layer through gas polymerization, which enables the direct polymerization of the conductive polymer on the film.

Further, the organic sulfonic acid compound may be used as a dopant for synthesizing the conductive polymer. Hence, upon preparation of the conductive polymer, even though the amount of the sulfonic acid compound is set in the range of the present invention to thus prepare the conductive polymer, the same effect may be obtained. That is, when the organic sulfonic acid compound is included in an amount not less than the amount required to serve as the dopant for synthesizing the conductive polymer, the organic sulfonic acid compound other than the amount used as the dopant is responsible for increasing the adhesive strength.

In the present invention, the substrate includes glass or highly transparent polymers having visible light transmittance of 85% or more for use in optical purposes, such as polyethersulfone, cyclic olefin compounds, polycarbonate, polyester, or polystyrene.

The surface resistivity of the antistatic layer is controlled in the range of 10²˜10¹⁰ ohm/sq. When the surface resistivity is low, antistatic performance is advantageously exhibited. However, if the surface resistivity is too low, visible light transmittance may be decreased. On the other hand, if the surface resistivity is too high, antistatic performance may be deteriorated.

### MODE FOR THE INVENTION

A better understanding of the present invention may be obtained in light of the following examples, which are set forth to illustrate, but are not to be construed to limit the present invention.

<Evaluation of Properties>

Measurement of Surface Resistivity: An antistatic solution was applied on one surface of a polarizer film, and was then dried, thus forming an antistatic layer. The surface resistivity of the antistatic layer was measured using a surface resistivity tester (ST-3, available from Simco).

Evaluation of Adhesive Strength: An antistatic solution was applied on one surface of a polarizer film, and was then dried, thus forming an antistatic layer. The adhesive strength of the antistatic layer was evaluated according to ASTM D3359.

Measurement of Charging Voltage: An antistatic layer was formed on one surface of a polarizer film, after which an acrylic adhesive for a polarizing plate was applied to a thickness of about 20□ on the antistatic layer of the polarizer film, and a release film was attached to the upper surface of the adhesive layer, thereby manufacturing a polarizer film having a structure of polarizer film/antistatic layer/adhesive layer/release film. The adhesive of the polarizer film was aged at room temperature for about 7 days. The charging voltage occurring on the polarizer film when the release film was removed from the polarizer film was measured using an electrostatic fieldmeter (FMX-002, available from Simco).

Evaluation of Reworkability: An antistatic layer was formed on one surface of a polarizer film, after which an acrylic adhesive for a polarizing plate was applied to a thickness of about 20□ on the antistatic layer of the polarizer film, and a release film was attached to the upper surface of the adhesive layer, thereby manufacturing a polarizer film having a structure of polarizer film/antistatic layer/adhesive layer/release film. As the adhesive of the polarizer film, an adhesive subjected to corona treatment and an adhesive not subjected to corona treatment were used, aged at room temperature for about 7 days, and then attached to a glass substrate under predetermined pressure. The film was allowed to stand at room temperature for 48 hours. Thereafter, when separating the polarizer film from the glass substrate, whether the adhesive remained on the glass substrate was evaluated according to the following criteria.

◯: no adhesive remained on glass substrate

Δ: some adhesive remained on glass substrate

X: most adhesive remained on glass substrate

### Comparative Example 1

Baytron P, as an aqueous dispersion of a conductive polymer, available from H. C. Starck, Germany, was applied on the surface of a polarizer film, and was then dried, thus forming an antistatic layer 0.2□ thick. The surface resistivity and adhesive force of the antistatic layer were measured. Thereafter, on the antistatic layer, an adhesive layer composed of an acrylic adhesive was formed, and a release film was attached to the upper surface of the adhesive layer. The charging voltage, occurring when the release film was removed, was measured. Further, the reworkability of the polarizer film attached to the substrate was evaluated. The results are shown in Table 1 below.

### Comparative Example 2

The present example was conducted in the same manner as in Comparative Example 1, with the exception that the surface of the acrylic adhesive was subjected to corona treatment, and thus the reworkability was evaluated.

### Comparative Example 3

The present example was conducted in the same manner as in Comparative Example 1, with the exception that 5 parts by weight of Baytron P, as the aqueous dispersion of the conductive polymer, available from H. C. Starck, Germany, and 10 parts by weight of a urethane binder were mixed with 85 parts by weight of ethylalcohol, thus preparing an antistatic coating solution, which was then applied on a polarizer film, and was then dried, thus forming an antistatic layer.

### Comparative Example 4

The present example was conducted in the same manner as in Comparative Example 3, with the exception that the surface of the acrylic adhesive was subjected to corona treatment, and thus the reworkability was evaluated.

TABLE 1

| | C. Ex. 1 | C. Ex. 2 | C. Ex. 3 | C. Ex. 4 |
|---|---|---|---|---|
| Adhesive Strength | 3B | 3B | 5B | 5B |
| Surface Resistivity (ohm/sq) | 1E4 | 1E4 | 1E5 | 1E5 |
| Charging Voltage (kV) | 0.4 | 0.4 | 0.6 | 0.6 |
| Reworkability | X | X | X | Δ |

As is apparent from Table 1, when the antistatic layer including the conductive polymer as an effective component was formed on the polarizer film, the charging voltage was measured to be 1 kV or less, resulting in excellent antistatic performance. However, in Comparative Examples 1 and 2, using only the aqueous dispersion of the conductive polymer that is commercially available, the adhesive force between the polarizer film and the antistatic layer was observed to be decreased, and thus the films could not be used. In Comparative Examples 3 and 4, using the conductive polymer in a mixture with the binder, the adhesive strength between the polarizer film and the antistatic layer was increased, but the adhesive strength between the antistatic layer and the adhesive layer was not significantly increased, thus causing problems related to the transfer of the adhesive to the substrate in the rework process.

### Example 1

The present example was conducted in the same manner as in Comparative Example 2, with the exception that an antistatic layer was formed on the polarizer film using the following antistatic solution.

In order to prepare the antistatic solution, into a 250 ml round bottom flask, 15 parts by weight of polystyrene sulfonic acid (PSSA), 1 part by weight of ammonium persulfate (APS), 3 parts by weight of ethylenedioxythiophene (EDOT), and 81 parts by weight of water were sequentially added, and were then magnetically stirred at 0° C. for 24 hours, thereby polymerizing polyethylenedioxythiophene doped with PSSA.

The polyethylenedioxythiophene thus polymerized was filtered using a 1□ sized filter to have a particle size less than 1□, and was then passed through an ion exchange resin (Lewatit MonoPlus S100), thus eliminating unreacted residue.

5 parts by weight of an aqueous dispersion of polyethylenedioxythiophene/PSSA thus polymerized was diluted with 95 parts by weight of ethylalcohol, thus preparing the antistatic coating solution for a polarizer film.

The coating solution was applied on the surface of the polarizer film and was then dried, thereby forming the antistatic layer. The adhesive strength, surface resistivity, charging voltage, and reworkability thereof were measured using the same process as in the comparative example. The results are shown in Table 2 below.

### Example 2

The present example was conducted in the same manner as in Example 1, with the exception that 25 parts by weight of PSSA, 1 part by weight of APS, 3 parts by weight of EDOT, and 71 parts by weight of water were mixed to thus prepare polyethylenedioxythiophene doped with PSSA when preparing the antistatic solution for a polarizer film.

### Example 3

The present example was conducted in the same manner as in Example 1, with the exception that polymaleic acid was used, instead of PSSA, to thus prepare polyethylenedioxythiophene doped with polymaleic acid when preparing the antistatic solution for a polarizer film.

### Example 4

The present example was conducted in the same manner as in Comparative Example 2, with the exception that the aqueous dispersion of poly(3,4-ethylenedioxythiophene), available from H. C. Starck, Germany, was added with PSSA so that the ratio of the poly(3,4-ethylenedioxythiophene) to the PSSA was set to 1:10 when preparing the antistatic solution for a polarizer film.

### Example 5

The present example was conducted in the same manner as in Comparative Example 2, with the exception that the aqueous dispersion of poly(3,4-ethylenedioxythiophene), available from H. C. Starck, Germany, was added with dodecylbenzene sulfonic acid so that the ratio of the poly(3,4-ethylenedioxythiophene) to the dodecylbenzene sulfonic acid was set to 1:15 when preparing the antistatic solution for a polarizer film.

TABLE 2

| | Ex. 1 | Ex. 2 | Ex. 3 | Ex. 4 | Ex. 5 |
|---|---|---|---|---|---|
| Adhesive Strength | 5B | 5B | 5B | 5B | 5B |
| Surface Resistivity (ohm/sq) | 1E4 | 1E6 | 1E5 | 1E4 | 1E5 |
| Charging Voltage (kV) | 0.4 | 0.8 | 0.5 | 0.4 | 0.6 |
| Reworkability | Δ | ◯ | ◯ | ◯ | ◯ |

As is apparent from Table 2, when the antistatic solution of the invention was applied on the polarizer film, the polarizer film was imparted with excellent antistatic performance, and furthermore, the adhesive strength between the antistatic layer and the adhesive layer was increased, resulting in no problems related to the transfer of the adhesive to the glass substrate upon reworking.

### Example 6

The present example was conducted in the same manner as in Example 1, with the exception that the antistatic solution for a polarizer film was prepared using a conductive polymer in which poly(3,4-ethylenedioxythiophene) was copolymerized with polyethyleneglycol. As such, poly(3,4-ethylenedioxythiophene)-co-polyethyleneglycol was prepared as follows. 12 g of polyethyleneglycol, having a molecular weight of 400, and 6 ml of pyridine were mixed with dichloromethane, after which 7 ml of 2-thiophenecarbonyl chloride was added in droplets thereto, thereby preparing polyethyleneglycol having terminal thiophene. 0.7 mmol of polyethyleneglycol having the thiophene was mixed with 30 g of ferric toluene sulfonate in a butanol solvent. 1.6 g of 3,4-ethylenedioxythiophene was added in droplets thereto, therefore preparing poly(3,4-ethylenedioxythiophene)-co-polyethyleneglycol. The polymerization of the conductive polymer was realized through the stirring process at 80° C. for 3 hours. After the completion of the polymerization, the polymer was washed with water to eliminate the unreacted portion, thereby obtaining a final product.

The conductive polymer solution prepared in Example 6 was applied to a thickness of about 0.2□ on the polarizer film, and the surface resistivity thereof was measured to be 1E4 ohm/sq. Further, the charging voltage was measured to be about 0.5 kV, and thus desired antistatic performance was confirmed to be attained. Furthermore, in the evaluation of reworkability, there was no transfer of the adhesive to the substrate.

### INDUSTRIAL APPLICABILITY

As described hereinbefore, the present invention provides an antistatic coating composition for polarizer films and an antistatic polarizer film using the same. According to the present invention, the antistatic composition and the antistatic polarizer film using the same are suitable for use in liquid crystal displays.

1. An antistatic coating composition for a polarizer film, comprising a conductive polymer and an organic acid compound (in case of the conductive polymer having an organic acid compound as a dopant, added in addition to the acid compounds used as dopant for the conductive polymer), to apply the antistatic coating composition between the polarizer film and an adhesive layer.

2. The composition according to claim 1, wherein the organic acid compound is one or a mixture of two or more selected from a group consisting of polysulfonic acid compounds, including polystyrenesulfonic acid and polyvinylsulfonic acid, poly-carboxylic acid compounds, including polyacrylic acid, polymethacrylic acid and polymaleic acid, and low-molecular-weight organic acid compounds, including para-toluenesulfonic acid, benzenesulfonic acid, methanesulfonic acid and trifluoromethanesulfonic acid.

3. The composition according to claim 1, wherein the conductive polymer is selected from a group consisting of polyaniline, polypyrrole, polythiophene, derivatives thereof, which are modified conductive polymers thereof, including poly(3,4-ethylenedioxythiophene), hydroxymethylated poly(3,4-ethylenedioxythiophene), poly(3,4-alkylenedioxythiophene), poly(3,4-dialkylthiophene), poly(3,4-cycloalkylthiophene) and poly(3,4-dialkoxythiophene), and conductive polymers having a structural unit of the polythiophene-based conductive polymer and being copolymerized with a polymer, including polyethyleneglycol and poly(meth)acrylate.

4. The composition according to claim 1, wherein the organic acid compound is used in an amount of 1-50 times an amount of the conductive polymer, including poly(3,4-ethylenedioxythiophene) or thiophene-based conductive polymer derived therefrom.

5. The composition according to claim 1, wherein the conductive polymer and the organic acid compound are mixed with a solvent, the solvent being one or a mixture of two or more selected from a group consisting of water, alcohol solvents, including methylalcohol, ethylalcohol, isopropylalcohol and isobutyl alcohol, ketone solvents, including acetone, methylethylketone, methylisobutylketone and cyclohexanone, ether solvents, including diethylether, dipropyl ether and dibutyl ether, alcohol ether solvents, including ethyleneglycol, propyleneglycol, ethyleneglycol monomethylether (methylcellosolve), ethyleneglycol monoethylether (ethylcellosolve), ethyleneglycol monobutylether (butylcellosolve), diethyleneglycol, diethyleneglycol monoethylether and di-ethyleneglycol monobutylether, amide solvents, including N-methyl-2-pyrrolidinone, 2-pyrrolidinone, N-methylforaiamide and N,N-dimethylforaiamide, sulfoxide solvents, including dimethylsulfoxide and diethyl sulfoxide, sulfone solvents, including diethyl sulfone and tetramethylene sulfone, nitrile solvents, including acetonitrile, amine solvents, including alkylamine, cyclic amine and aromatic amine, and organic solvents, including toluene and xylene.

6. An antistatic polarizer film, comprising:
a base film;
an antistatic layer formed on one surface of the base film using the antistatic coating composition of claim 1; and
an adhesive layer formed on the antistatic layer.

7. The polarizer film according to claim 6, wherein the antistatic layer is formed through direct polymerization, gas polymerization, or liquid polymerization.

8. The polarizer film according to claim 6, wherein the antistatic layer has surface resistivity of 10²˜10¹⁰ ohm/sq.
